(19) United States
(12) Patent Application Publication
(10) Pub. No.: US 2006/0192063 A1
(43) Pub. Date: Aug. 31, 2006

(54) Platform extension and holder for a ladder

(76) Inventor: Michael A. Angotti, Palm Beach, FL (US)

Correspondence Address: EDWARDS & ANGELL, LLP, P.O. BOX 55874, BOSTON, MA, 02205, US

(21) Appl. No.: 11/414,901

(22) Filed: May 1, 2006

Related U.S. Application Data
(63) Continuation-in-part of application No. 10/932,793, filed on Sep. 2, 2004.

(51) Int. Cl. E06C 5/32; E06C 7/14

(52) U.S. Cl. 248/210; 182/129; 248/310

(57) ABSTRACT

A platform extension for securing items to a ladder. The platform extension consists of a substantially planar substrate A container is selectively, releasably attached to the substrate. The planar substrate releasably affixed to a ladder.

### CROSS-REFERENCE TO RELATED APPLICATIONS

This is a continuation-in-part of U.S. Patent Application Ser. No. 10/932,739, filed Sep. 2, 2004, entitled PLATFORM EXTENSION AND HOLDER FOR A LADDER.

### BACKGROUND OF THE INVENTION

This invention is directed to a platform extension for a ladder, and more particularly, to a platform extension for stably holding tools, paint cans and the like when resting on a ladder.

A-frame ladders have been known for decades. They have become one of the staple tools for doing any activity, which is performed at a height, yet requires a stable base. These activities include household repair, painting, construction, or the like. The most common version of the A-frame ladder includes a top, a first side having steps contained therein is connected to the top. A support, connected at the top platform is separated from the steps across an acute angle to form an A with the step structure. The top of the A-frame ladder usually forms a platform upon which tools, paint cans or the like may rest.

The top platform is limited in area. Therefore, it is known to provide a secondary platform rotatably mounted to the support of the ladder near the top of the ladder. A person standing on the steps can reach over the top and access the platform extending from the support side of the ladder.

Ladders have been satisfactory, however they suffer from the deficiency that the platforms are limited in their stability so that if the ladder is jostled or moved while an item is resting on either the top or the platform of the ladder, it has a tendency to fall off the ladder. Furthermore, the size of the platform and top are limited. Accordingly, when performing a task that requires constant movement of the ladder, such as painting a larger area, such as the interior of the house, or fixing wiring which extends along a wall, all of the tools must be removed from the ladder each time the ladder is repositioned, otherwise they tend to fall off. This repetitive carrying of tools up and down the ladder results in a waste of time, and with heavy tools, can become a tiring unnecessary chore. Furthermore, because the user must carry the tools or paint can while ascending or descending the ladder, the user cannot use their hands; an unsafe condition.

Accordingly, a device for overcoming the shortcomings of A-frame ladders is desired.

### BRIEF SUMMARY OF THE INVENTION

A platform extension and holder includes a substantially planar substrate. A wall extending from the substrate forms a substantially self-enclosed, open-topped structure on a first side of the platform. An anchor anchors the substrate to the ladder.

In a preferred embodiment, the container is an open-top cylinder dimensioned to receive a can of paint. The anchor cooperates with a step of the ladder for anchoring the platform to a ladder top.

In another embodiment of the invention, the anchor cooperates with the rotatable platform of the ladder and is secured on the rotatable platform of the ladder. Still further, the container may be releasably affixed to the substrate.

### BRIEF DESCRIPTION OF THE DRAWINGS

For a fuller understanding of the invention, reference is had to the following description, taken in connection with the accompanying drawings, which are not drawn to scale, in which:

FIG. 1 is a side elevational view of a platform extension constructed in accordance with the invention;

FIG. 2 is a top plan view of a platform extension constructed in accordance with the invention;

FIG. 3 is a side elevational view of a platform extension constructed in accordance with a second embodiment of the invention

FIG. 4 is top plan view of a platform extension constructed in accordance with the second embodiment of the invention;

FIG. 5 is a sectional view taken along line 5-5 of FIG. 4;

FIG. 6 is a front perspective view of the platform extension constructed in accordance with a third embodiment of the invention;

FIG. 7 is an exploded view of the platform extension constructed in accordance with the invention;

FIG. 8 is a side perspective view of a platform extension constructed in accordance with the invention;

FIG. 9 is a sectional view taken along line 9-9 of FIG. 8;

FIG. 10 is a front perspective view of a platform extension constructed in accordance with a fourth embodiment of the invention; and

FIG. 11 is a side perspective view of a platform extension constructed in accordance with the invention.

### DETAILED DESCRIPTION OF THE INVENTION

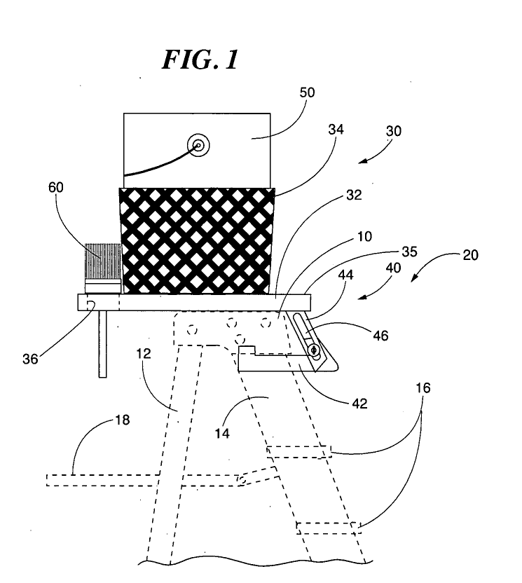

Reference is made to FIG. 1 in which an A-frame ladder, generally indicated as 20, includes a top 10. A support member 12 extends from top 10, and a step member 14 extends from top 10 spaced from and at an angle from support member 12 to substantially form an A-shape. Step member 14 includes a plurality of steps 16 disposed therein. A platform 18 is rotatable affixed to support member 12.

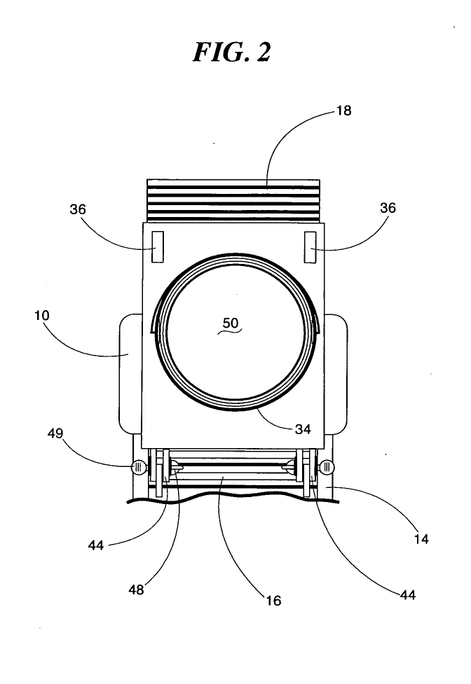

Platform extension, generally indicated as 30, includes a substantially planar substrate 32. A wall 34 is disposed on substrate 32 and extends from a top surface 35 thereof. Wall 34 forms an open-topped, substantially enclosed container (FIG. 2). An anchor 40 connected to planar substrate 32 anchors planar substrate 32 to ladder 20.

In a preferred embodiment, container 34 is integrally formed with substrate 32 and may, by way of non-limiting example, be formed of plastic. However, it should be understood that extension 30 may be formed of a lightweight metal such as aluminum or the like or any other lightweight, rigid, durable material. To save weight, wall 34 may be formed as a honeycombed construction as shown in FIG. 1.

Planar substrate 32, in a preferred, but not limiting embodiment, has a length and/or width greater than a length and/or width of ladder top 10 to provide a larger and more stable support platform for wall 34 and whatever may be contained therein. Furthermore, wall 34 is formed as a sidewall extending from substrate 32 and in a preferred embodiment provides a circumscribing structure as seen in FIG. 2 to act as a container. However, wall container 34 need only extend sufficiently to steadily hold the contents within wall 34. Wall 34 may be utilized to hold tools, such as hammer, wrench, screwdriver, nuts, bolts and nails. In such an instance, wall 35 would preferably be formed as a solid wall as opposed to honeycombed.

If being used to hold a paint container, wall 34 is sized and shaped to slideably receive and retain a paint can therein. The distance between wall 34 and a paint can 50 contained therein should be sufficiently small to allow paint can 50 to easily slide from wall 34, yet prevent paint can 50 from rocking, sliding or falling out of wall 34 during movement of ladder 10. Furthermore, in a preferred embodiment the height of wall 34 should be at least as high as one-third to half the height of paint can 50 which is received therein to retain paint can 50 therein during movement of ladder 10.

In a preferred embodiment, when used to hold a paint can, substrate 32 may also include slots 36 formed therein capable of receiving a tool such as a paintbrush 60, a hammer, or even dimensioned to receive a screwdriver or wrench without the tool passing therethrough. In this way, a user of ladder 20 need not climb the ladder with hands full of tools, paint cans or the like facilitating quick, efficient movement of the ladder and safer ascending and descending of the ladder.

In the preferred embodiment, anchor 40 includes a substantially C-shaped member 42 connected to substrate 32 at one end and adapted to catch top 10 at another end. In this manner, C-shaped member 42 connects substrate 32 to top 10 and anchors it thereto. To accommodate a variety of different sized ladders, C-shaped member 42 is adjustably connected to substrate 32.

In a preferred embodiment, substrate 32 includes a flange 44 having a slot 46 therein. A nut 48 and bolt 49 combination passes through C-shaped clamp 42 at slot 46 such that bolt 48 travels within slot 46 of flange 44. In this way, C-shaped member 42 can effectively be lengthened or shortened relative to substrate 32 and the size of top 10 by bolt 49 riding through slot 46 and being tightened in the appropriate position, i.e., the position at which C-shaped clamp 42 engages top 10.

It should be noted, that anchor 40 can be formed by any structure, which applies a force to bring substrate 32 towards top 10. C-member 42 may be replaced with a hook, a strap extending from substrate 32, a bungee cord, a rope or the like. As a result, anchor 40 is adjustable to accommodate a variety of ladder sizes.

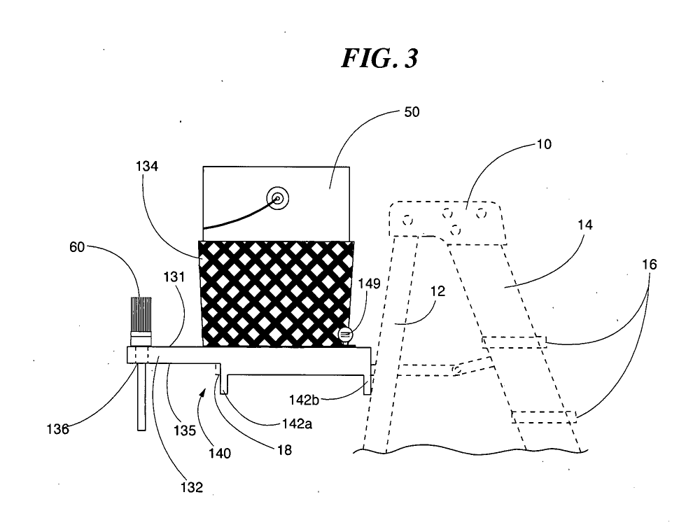

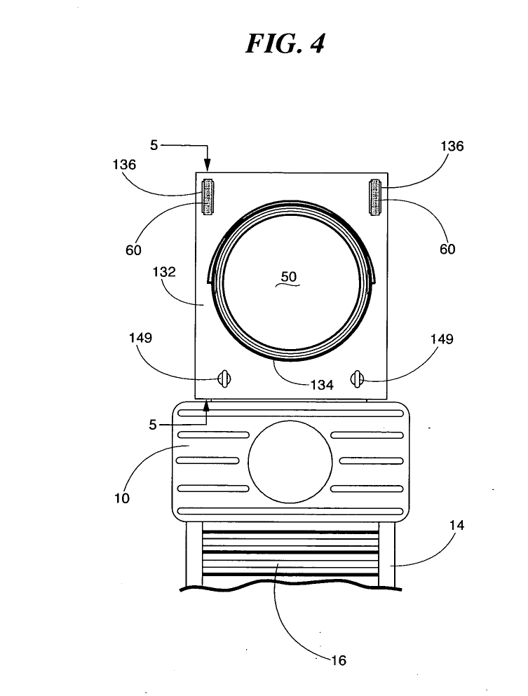

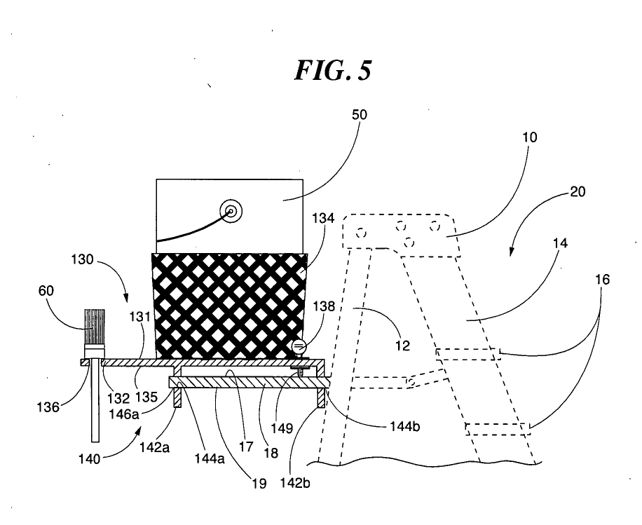

It should be noted, that the illustrations in FIGS. 1 and 2 are by way of example only. The wall 34 of container of this embodiment as well as the embodiment of FIGS. 3-5 described below, when solid, can also contain the liquid directly without the need for a can. Furthermore, wall 34, as discussed above, can be sized to receive any can. However, an adaptor can be inserted within wall 34 to accommodate smaller diameter cans than can 50. In this way, a single platform could accommodate a one-gallon can as well as a quart can.

Platform extension 130 includes a substantially planar substrate 132. A wall 134 extends from a top surface 131 of substrate 132. Wall 134 forms a substantially circumscribed shape and may be sized and shaped to receive a paint can as described above. However, in other embodiments in which extension 130 is being utilized to hold tools such as nails, nuts, bolts or hooks, the circumscribed shape can be of any necessary size. Again, wall 134 may be formed of a honeycombed pattern to save on weight and material. However, it can be formed solidly. Additionally, it may be integrally formed with substrate 132, or may be removably attached by Velcro® fasteners, snaps, hooks or the like as known in the art.

In a preferred embodiment, substrate 132 is greater in at least one dimension, such as length, or width than platform 18 to which it is attached. Because, as in this example, substrate 132 has a length greater than that of platform 18, slots 136 may be formed in substrate 132 for receiving tools therein, such as paint brush 60 by way of example or a hammer, screwdriver, wrench or the like.

An anchor, for attaching to ladder 20 connects substrate 132 to platform 18. Anchor 140 is a structure adapted to receive platform 18 therein and to secure itself to platform 18. Anchor 140 includes at least a first member 142a extending from a bottom surface 135 of substrate 132; a direction opposed to the direction of extension of wall 134. Member 142a is formed with a slot 146a therein, sized and dimensioned to receive platform 18 therethrough. Slot 146a includes at least a bottom surface 144a.

A threaded bolt 149 extends through and cooperates with a threaded opening 138 of substrate 132. Threaded bolt 149 has a length sufficient to come into pressing contact with platform 18 when threaded bolt 149 is disposed within threaded opening 138.

A second descending member, 142b has a slot 146b formed therein having a bottom surface 144a. Slot 146b also receives platform 18.

During use, extension 130 is placed onto platform 18, by platform 18 being received in slots 146a, 146b. Screws 149 are tightened against a top surface 17 of platform 18 effectively raising substrate 132 relative to platform 18. As a result, a bottom surface 19 of platform 18 comes in contact with a bottom surface 144a, 144b of respective depending members 142a, 142b so that platform 18 is pinned between bolt 149 and the bottom surface 146 of a respective slot 146.

Again, anchor 140 can be substituted with a hook mechanism, strap mechanism, or any other substitute which affixes substrate 132 to platform 18.

By providing a platform having a wall which essentially forms a container thereon and anchoring the platform to a portion of the ladder, a device/adaptor is provided which maintains objects being used during a project, such as paint cans, paint brushes, tools, nuts and bolts on the ladder, while the ladder is being repositioned from one location to another. As a result, work is done more efficiently as it is no longer necessary to remove everything from the ladder when repositioning it. Tools, paint, etc. are more stably maintained on the ladder during the job, and safer work is performed as the user of the ladder no longer has to repeatedly climb up and down the ladder with tools, paint and the like in their hands.

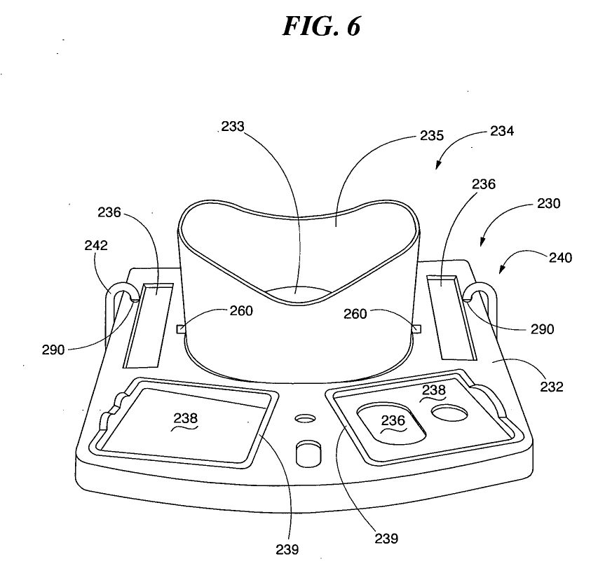

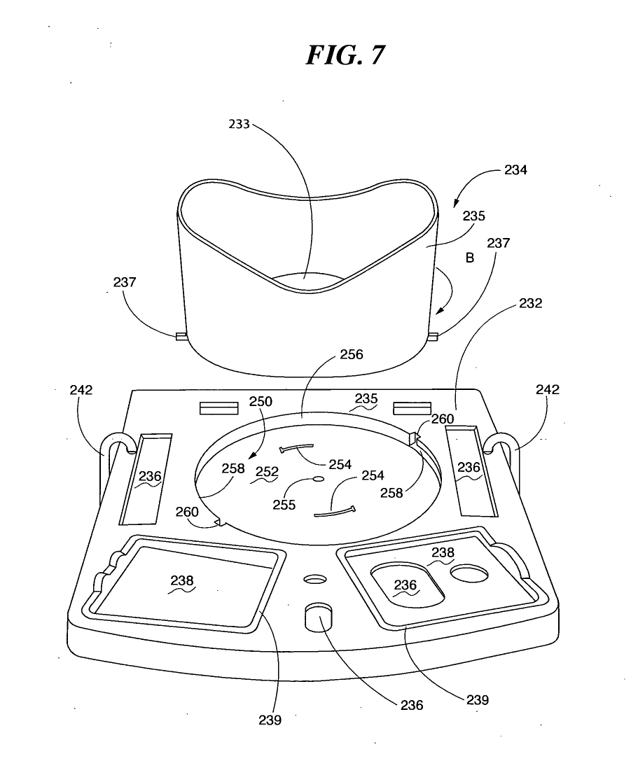

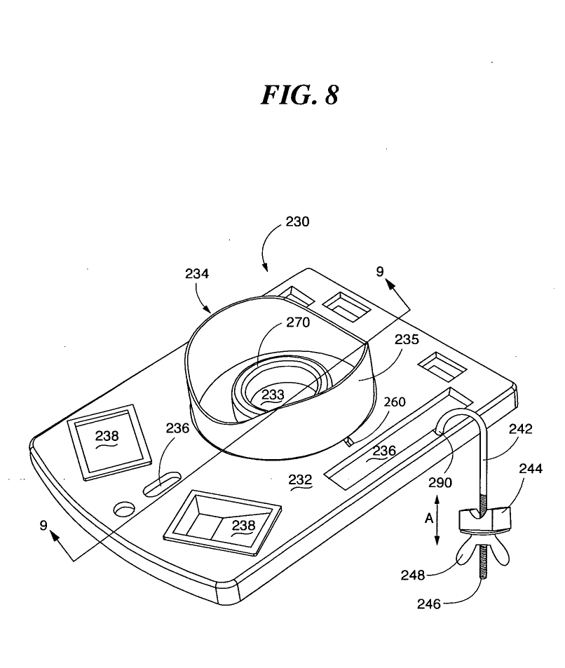

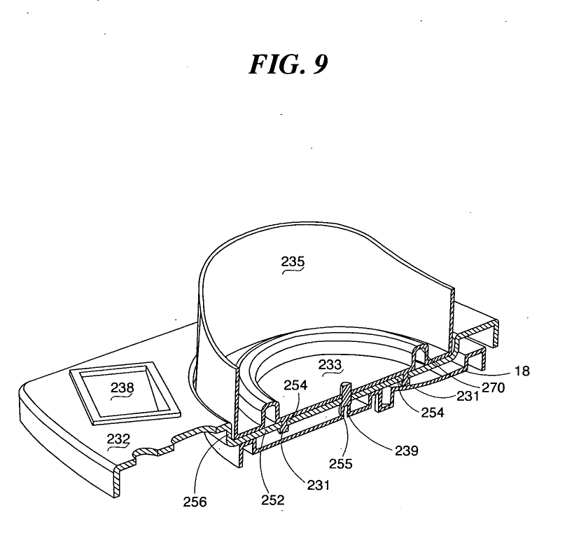

Reference is now made to FIGS. 6-9 in which a platform extension, generally indicated as 230, constructed in accordance with a third embodiment of the invention, is provided. The substantial difference between this embodiment and the other embodiments of the invention being the container is removably attached to the substrate.

Platform extension 230 has a planar substrate 232, which, in a preferred, but not limiting environment, has a length and/or width greater than and a length and/or width of ladder top 10 or platform 18. This is to allow an embodiment with slots 236 so that there is clearance to hang tools therethrough. However, it should be understood that it well within the concept of the invention, particularly with respect to the container 234, that substrate 232 could be smaller in area than either top 10 or platform 18. However, it is preferred that the area be greater to provide a larger and more stable support platform.

A container 234 is disposed on substrate 232. Container 234 includes a bottom 233 and a wall 235 extending therefrom in a direction away from substrate 232. Wall 235 and bottom 233 form an open top, substantially enclosing container 234. Container 234 includes at least one tab 237 extending from wall 235. At least one projection 231 extends from bottom 233. In a preferred embodiment, projections 231 are substantially T-shaped. A pivot 239 is provided at substantially the center of bottom 233.

Container 234 is used to hold objects whether they be solid parts, tools or the like, or liquid such as paint, cleansing materials or the like. As discussed above, if being used to hold a paint container, wall 235 is sized and shaped to slidably receive and retain a paint can therein. The distance between wall 235 and a paint can contained therein should be sufficiently small to allow the paint can to easily slide from container 234, yet prevent the paint can from rocking, sliding or falling out of container 234 during movement of ladder 10.

It should be noted, that a gallon paint can is much larger than a quart paint can. To accommodate paint cans of both sizes, a retaining ring 270 is disposed on bottom 233 having a diameter to retain a quart paint can therein. Again, distance between retaining ring 270 and a quart paint can contained therein is sufficiently small to allow the paint can to easily slide from the area within the ring, yet prevent the can from rocking, sliding or falling out.

In a preferred, non-limiting example, container 234, tabs 237, ring 270, and projections 231, 239, are all formed as a single integral component. Preferably, a molded component.

Similar to the other embodiments, substrate 232 may include slots 236 formed therein capable of receiving a tool such as a paintbrush, hammer, screw driver or wrench without the tool passing therethrough. Additionally, trays 238 may be formed in larger openings in substrate 232 and supported within the opening by a rim 239. Alternatively, tray 238 may be integrally formed with substrate 232.

A support section 250 is provided in substrate 232 for selectively, releasably maintaining container 234 attached to substrate 232. Support section 250, in a preferred non-limiting embodiment, is a recessed portion. However, it should be understood that several of the retaining mechanisms would operate without a recess. Support section 250 includes a floor 252 and, in a preferred embodiment, at least one retaining slot 254. Retaining slot 254 is sized and dimensioned to receive a respective projection 231. In the preferred embodiment, one end of retaining slot 254 is larger than the remainder of the slot to accommodate the large head of the T-shaped projection 231 at one end and prevent release as projection 231 moves along slot 254.

Sidewalls 256 form the recess and extend from a top surface of platform 232 to floor 252. At least one guide slot 260 is formed along the circumference of support section 250. At least one retaining slot 258 extends partially within wall 256. A centering hole 255 is formed at the center of floor 252.

Guide slots 260 are sized and positioned to receive tabs 237 therein. Retaining slots 254 are sized to receive and retain tabs 237. As is understood by those skilled in the art, guide slots 260 are positioned relative to retaining slots 254 such that when tabs 237 are received by guide slots 260, projections 231 are received by retaining slots 254. Therefore, guide slots 260 act as alignment guides. Container 234 is then rotated in the direction of arrow B so that projections 231 slide along slots 254 for retention therein while tabs 237 slide along slots 258 for further retention of container 234.

It should be noted that the extension platform of this embodiment utilizes two retention structures, tabs 237 and projections 231. However, it is within the scope of the invention to operate with the retention capabilities of the slots 258 only, no slots, and the retention capabilities of the retaining slots 254 only, or a single projection 231. In this way, container 234 is selectively releasably retained to substrate 232. It should be noted that Velcro® strips, snaps, or any other fastener may be used between bottom 233 and support section 250.

Anchors 240 are provided in a preferred, non-limiting embodiment to secure substrate 242 to top 10 or platform 18. In this embodiment, anchors 240 include a substantially J-shaped member 242. J-shaped member 242 is threaded along at least a portion thereof. A nut 248 engages the thread 246 of J-shaped member 242 to move along J-shaped member 242 in the directions of double-headed arrow A. An engagement member 244 located between substrate 232 rides on nut 248 in the directions of double-headed arrow A to engage the appropriate portion of ladder 10.

In a preferred embodiment, notches 290 may be formed within substrate 22 for placement and positioning of anchor 240. Additionally, as notch 290 engages J-shaped member 242, anchor 240 is tightened sufficiently to provide tension to maintain the anchor in place.

As is understood, because container 234 is selectively, releasably maintained by substrate 232, container 234 becomes interchangeable with other containers as a function of the job to be performed. Different types of containers more appropriate for their use, such as a paint can container, a solvent container, a container for nuts, bolts, and hinges or the like may be substituted for the simple walled container of platform extension 230.

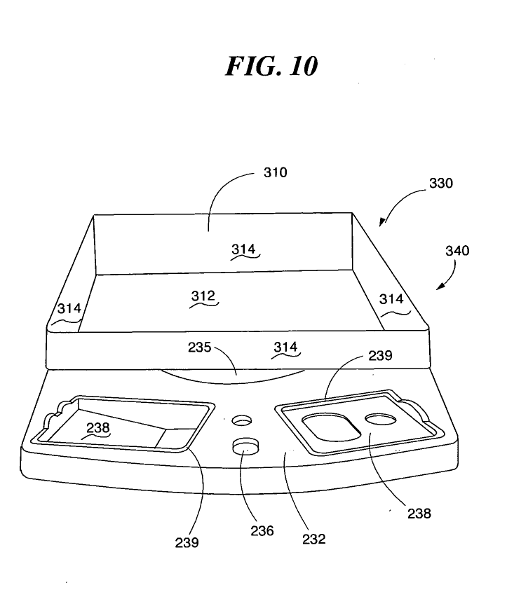

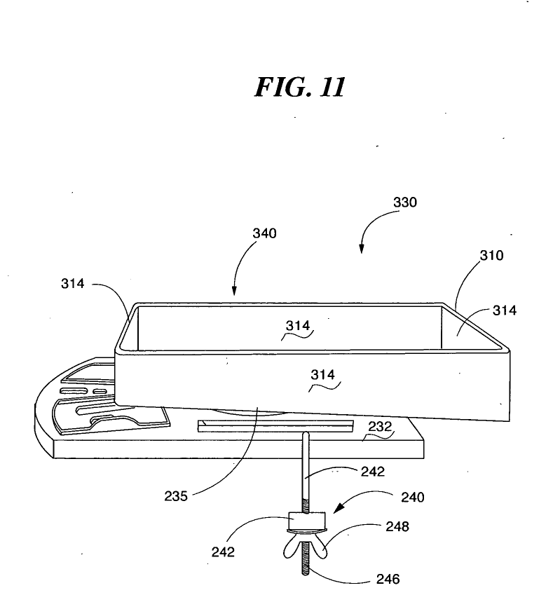

Reference is now made to FIGS. 10 and 11 in which a platform extension, generally indicated as 330 constructed in accordance with a fourth embodiment of the invention is provided. Like numerals are utilized to indicate like structures. The primary difference is that container 340 is shaped as a tray/pan such as a paint rolling pan.

Platform extension 330 includes a container 340 which is adapted to be selectively, releasably affixed or retained to substrate 232. Container 340 includes bottom 233 and wall 235. However, rather than being open-ended, a tray 310 includes a floor 312 resting on wall 235. Walls 314 define the perimeter about floor 312 forming the tray. As with the container 234, container 340 includes the structure shown in FIGS. 6, 7 and 9 for engaging substrate 232.

It should be understood, that the above examples were described in connection with a distinct substrate 232. However, it is within the scope of the invention that support portion 250 with its associated structure be formed directly into ladder 20. The structure may be formed at top 10 or in platform 18. It can be done by molding, metal stamping, wood milling, dependent upon the materials from which the ladder is made.

Thus, while there have been shown, described and pointed out novel features of the present invention as applied to preferred embodiments thereof, it will be understood that various omissions and substitutions in changing the form and details of the disclosed invention may be made by those skilled in the art without departing from the spirit and scope of the invention. It is the intention, therefore, to be limited only as indicated by the scope of the claims appended hereto. It is also to be understood that the following claims are intended to cover all of the generic and specific features of the invention herein described and all statements of the scope of the invention, which, as a matter of language, might be said to fall therebetween.

What is claimed as new and desired to be protected by Letters Patent of the United States is:

1. A platform extension for securing items to a ladder, the platform extension comprising:
a substantially planar substrate being releasably affixed to a ladder;
a container selectively, releasably attached to said substrate.

2. The platform extension of claim 1, further comprising an anchor for anchoring the substrate to a ladder.

3. The platform extension of claim 1, wherein said container includes a bottom and a wall extending from said bottom, and the platform including a support portion, said container selectively, releasably engaging with said support portion.

4. The platform extension of claim 3, wherein said support portion is formed as a recess in said substrate.

5. The platform extension of claim 3, wherein said support portion includes at least one retaining slot formed therein for engaging said container and retaining said container to said substrate.

6. The platform extension of claim 3, wherein said support portion includes a guide slot formed along a circumference of said support portion and guiding said container into engagement with said support portion.

7. The platform extension of claim 3, further comprising projections extending from said container and engaging with said support portion.

8. The platform extension of claim 3, further comprising tabs extending from said wall and positioned and sized to be received at said support portion for guiding said container into engagement with said support portion.

9. The platform extension of claim 5, further comprising at least one projection extending from said container, said projection sized to be received by at least one retaining slot.

10. The platform extension of claim 6, further comprising at least one guide tab extending from said container, received by at least one guide slot.

11. The platform extension of claim 9, further comprising at lease one guide slot formed in the periphery of said support portion and at least one guide tab extending from said container to be received by said at least one guide slot.

12. The platform extension of claim 4, further comprising at least one guide slot formed along a circumference of said support portion.

13. The platform extension of claim 12, wherein said recess includes a floor and a wall, a retaining slot formed along said wall and extending from said at least one guide slot.

14. The platform extension of claim 2, wherein said anchor comprises a J-shaped member having threading along at least a portion thereon; a nut engaging said threaded portion for reciprocal movement along said J-shaped portion and an engaging member disposed on said nut.

15. A ladder having a top and a platform comprising:
a container being selectively, releasably affixed to at least one of said top and platform.

16. The ladder of claim 15, wherein said container includes a bottom and a wall extending from said bottom, and a support portion formed on at least one of said top and platform, said bottom being selectively, releasably engaging with said support portion.

17. The ladder of claim 16, wherein said support portion is formed as a recess in said substrate.

18. The ladder of claim 16, wherein said support portion includes at least one retaining slot formed therein for engaging said container and retaining said container to said substrate.

19. The ladder of claim 16, wherein said support portion includes a guide slot formed along a circumference of said support portion and guiding said container into engagement with said support portion.

20. The ladder of claim 16, further comprising projections extending from said container and engaging with said support portion.

21. The ladder of claim 16, further comprising tabs extending from said wall to be received and sized to be received at said support portion for guiding said container into engagement with said support portion.

22. The ladder of claim 18, further comprising projections extending from said container, said projections sized and adapted to be received by at least one engaging slot.

23. The ladder of claim 19, further comprising at least one guide tab, received by at least one guide slot.

24. The ladder of claim 23, further comprising at lease one guide slot formed in the periphery of said support portion.

25. The ladder of claim 17, further comprising a guide slot formed along a circumference of said support portion.

26. The ladder of claim 23, wherein said recess includes a floor and a wall, a retaining slot formed along said wall and least one guide slot to engage said guide tab.
